(19) United States
(12) Patent Application Publication
(10) Pub. No.: US 2003/0094143 A1
(43) Pub. Date: May 22, 2003

(54) Newborn animal dryer and handling process

(76) Inventor: John F. Anderson, Cannon Falls, MN (US)

Correspondence Address: Nickolas E. Westman, WESTMAN CHAMPLIN & KELLY, International Centre, Suite 1600, 900 South Second Avenue, Minneapolis, MN, 55402-3319, US

(21) Appl. No.: 09/990,653

(22) Filed: Nov. 20, 2001

(51) Int. Cl. A01K 29/00

(52) U.S. Cl. 119/651

(57) ABSTRACT

A warming and drying housing is provided with a support wall for the animal that will place the animal in a position where clean, heated air can be passed over the animal for drying and warming a newborn animal. The housing can have a support formed as a shelf that can be slid in and out of the housing, or the housing can have other types of openings, such as hinged doors or hinged side panels that open to permit access. A transport cart for the animals can be coordinated with the type of housing being used so that an animal can be transported in the cart, washed and partially dried in the cart if desired, and then moved into the warming and drying housing easily.

### BACKGROUND OF THE INVENTION

The present invention relates to a handling process for reducing fatalities of newborn animals, in particular, newborn calves, by immediately after birth, placing the newborn animal in a dryer environment for drying the newborn animal as shown, a calf, to ensure the calf's temperature does not drop and that there is protection against diseases.

Loss of newborn animals, in particular calves, from various infectious diseases greatly increased by the inability of the baby animal to recover from the birth process before the immune system is activated enough to resist bacterial, viral and parasitic diseases that may be transmitted to a calf from the environment of the maternity pen or room in which the mother cow and other mother animals are kept.

One of the keys to survival has been the rapid care of the baby animal so that the animal is cleaned and dried, and fed colostrum. The animal's passive and active immune systems will then be activated quickly. This process also avoids having the calf kept in environments that are hazardous to the health of the animal.

### SUMMARY OF THE INVENTION

The present invention relates to a calf or other baby animal drying unit that is of a size to receive the newborn animal after a feeding of colostrum, and preferably after the animal has been washed and wiped or squeegeed dry. The drying unit provides a warming airflow over the animal to dry the baby and ensure that the baby animal does not become chilled. It then becomes active more quickly and will absorb more colostrum and, if necessary antibiotics for ensuring that the baby animal is not left in a weakened condition immediately after birth.

Additionally, the process involves the use of a transporting cart that can be wheeled from the birth site, such as a maternity pen, to the dryer housing. The cart is made so that it can be used for washing the animal while it is in the cart, and then transporting the animal to the drying and warming housing where a heater is provided to heat a flow of air that will pass over the calf or other animal to dry the calf. When dried and warmed, the calf becomes invigorated, hungry, and ready to receive food. Colostrum can then be fed to the animal through a bottle or esophogal feeders and when the animal's temperature is stabilized, and the animal is dried, and after it has received nutrition and disease fighting colostrum, it can be transported to an individual pen in a larger environment such as a calf hutch.

The drying and warming unit is made of size so that it will hold one or more animals easily. The animal can easily be slid or wheeled into the enclosure so that it will be protected from the exterior environment until it has gained strength enough for standing by itself, in a pen. The flow of air provided can be from a source known to be free of bacteria or the like, or a filter can be used on the intake so clean air flows over the animal.

In a modified form of the invention, a pen is made that is of size so that it will hold four or more baby calves for warming at once, with swing out doors that permit easily transferring an animal from a transfer cart onto a floor made of plastic covered expanded metal. Heated air is made to flow over the baby animals to permit them to dry and to keep them out of an environment that is likely to be filled with a bacteria, viruses or parasites, and the like.

Another form of the invention shows a housing having positions for a plurality of the transfer carts to be wheeled into place and the animals warmed while in the transfer cart.

When animals are in the present process, they are removed from the maternity pens as quickly as possible, and washed and squeegee dried or rubbed dry. This can be done inside a wheeled cart that has drain holes in it and a soft rubber pad so that the animal does not get bruised. The cart can be covered, and the animal taken to an intermediate holding pen where the animal can be temporarily left in the cart while air was blown over the animal to dry it. Air would pass through the perforations or openings in the pad and cart so that a flow of air was established, keeping, again, fresh, clean, warm air passing over the baby animal for drying. The animal can remain in the cart until dried and warmed fully as well.

Once the animal is in the drying housing, it is treated as in the first forms of the invention, and is quickly dried and then is ready for additional feeding. When baby animals dry off and warm up, they become very active and this means that they will take in and absorb colostrum and other food very quickly.

As part of the overall process, a unique cart has been developed that would permit transporting baby animals such as calves (which is the primary application) from the maternity pen or birthing place to the warming area and/or drying housings. The cart is a two wheel cart that is substantially standard in shape and in construction. The cart can be molded plastic, and will be provided with openings or apertures in the bottom so that liquid drainage and airflow can be established across or through the top of the cart. Additionally, hinges are provided for folding cover doors over the open top of the cart to prevent the animal from escaping, or even attempting to escape. The cover doors may be solid, or they can be open expanded metal that is covered with a suitable plastic to avoid injury to the animal. When expanded metal is used, air will flow into the cart with or without opening the cover doors, and then flow out through the apertures in the cart bottom for initial drying.

The animal is either removed from the cart or left in the cart to be placed into a friendly environment of the drying housing that has heated clean air flowing over the animal until it is dry and warmed thoroughly.

### BRIEF DESCRIPTION OF THE DRAWINGS

FIG. 1 is a perspective view of a first form of a calf dryer and warming unit made according to the present invention with a calf receiving tray in an extended position;

FIG. 2 is a side sectional view of the calf dryer unit of FIG. 1, showing the calf receiving tray in an installed position;

FIG. 3 is a large sectional view illustrating a track and slide that may be used with the tray of the present invention;

FIG. 4 is an end sectional view of a modified form of the present invention showing fold-down sides for receiving newborn calves for sliding them into the interior of the calf warming unit;

FIG. 5 is an enlarged fragmentary sectional view of a device of FIG. 4 showing a transport cart in a position to unload an animal in the cart onto the fold-down side of the devise of FIG. 4;

FIG. 6 is a plan view of the cart shown in FIG. 5 illustrating a schematic ability to drain the cart, with a pad in place;

FIG. 7 is a perspective view of a modified drying housing made according to the present invention and adapted to hold a plurality of baby animals, such as calves;

FIG. 8 is a top plan view of the housing of FIG. 7, illustrated with the doors open to receive calves;

FIG. 9 is a fragmentary view showing an animal transport cart used in transporting baby animals to the housing and in an unloading position;

FIG. 10 is a perspective view of a modified housing that may be used as an initial holding facility with the calves maintained in the transport cart, prior to introduction into the drying housings or actually being a drying housing where animals will be maintained at a selected temperature;

FIG. 11 is a front view of the animal transport cart shown in FIGS. 9 and 10;

FIG. 12 is a schematic side elevational view of a modified housing that is used wherein an animal transport cart can be placed into end doors of a double housing;

FIG. 13 is a top plan view of the housing of FIG. 12 with parts broken away;

FIG. 14 is a end view of the housing of FIG. 12; and

FIG. 15 is a schematic flow diagram of the process of the present invention.

### DETAILED DESCRIPTION OF THE ILLUSTRATIVE EMBODIMENTS

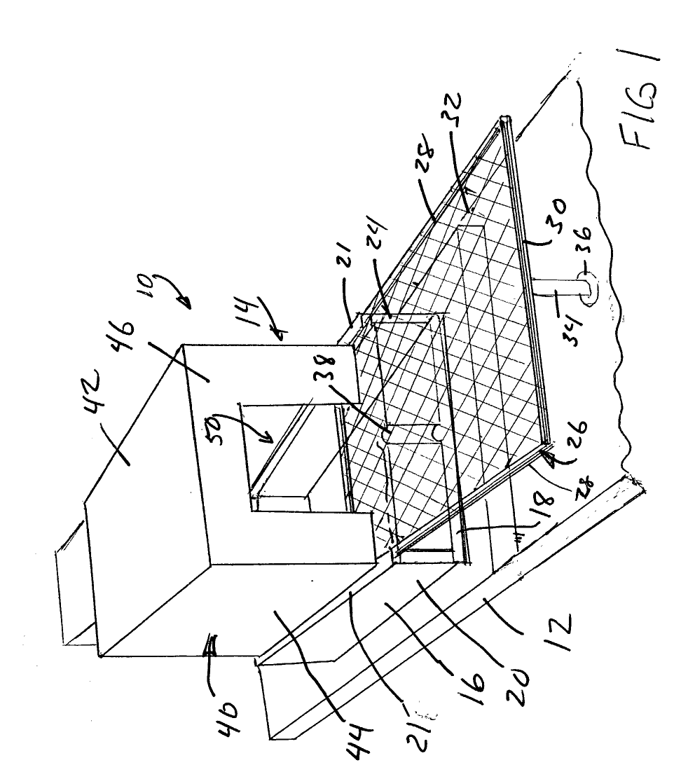

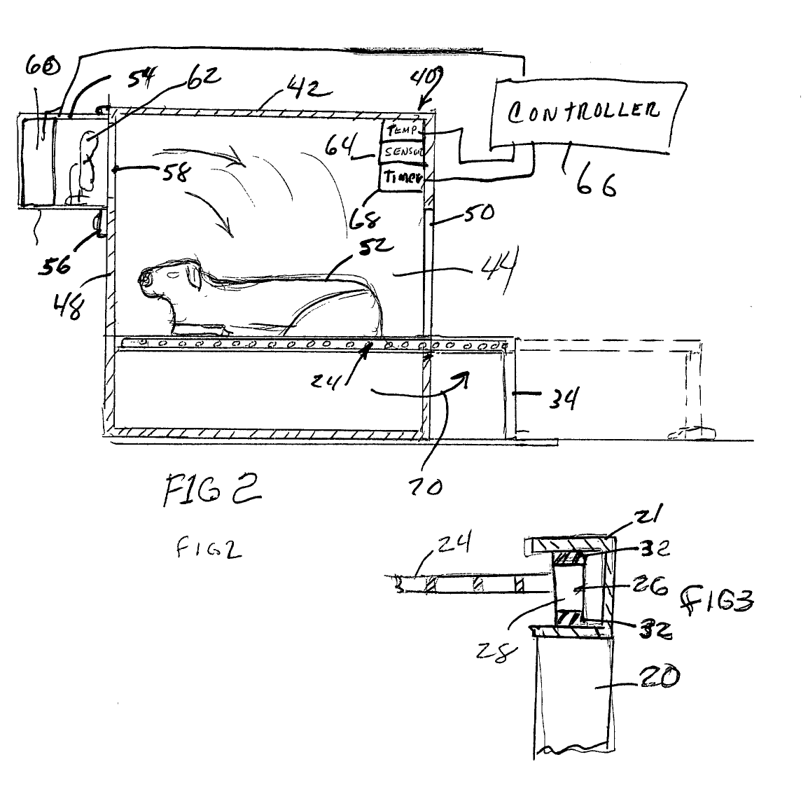

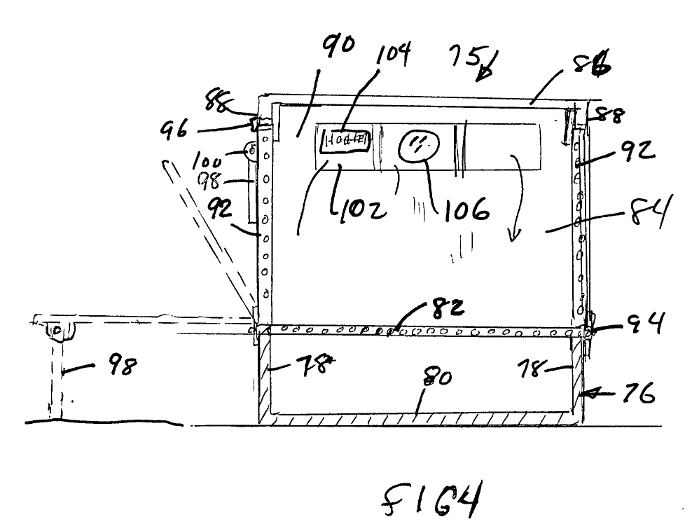

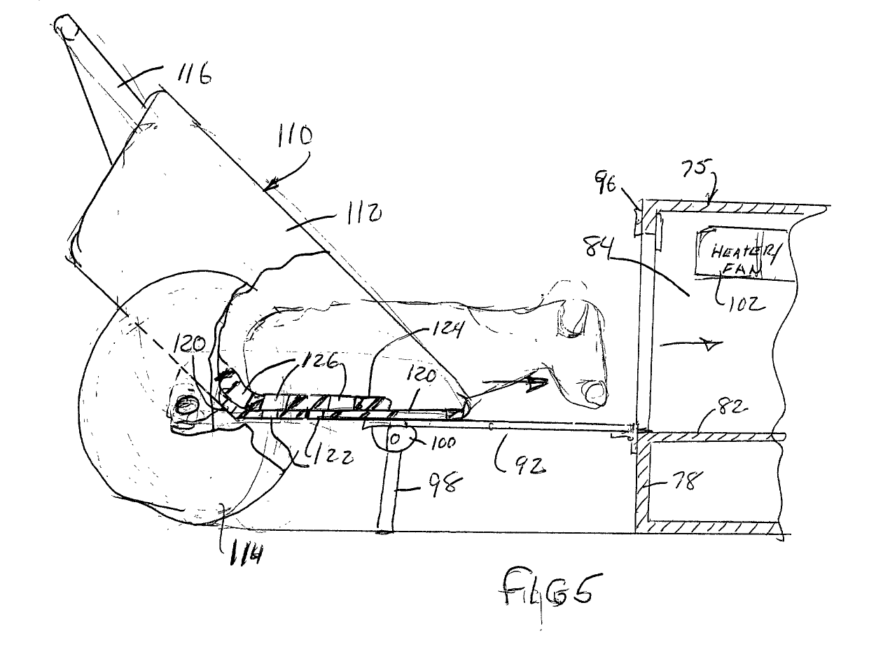

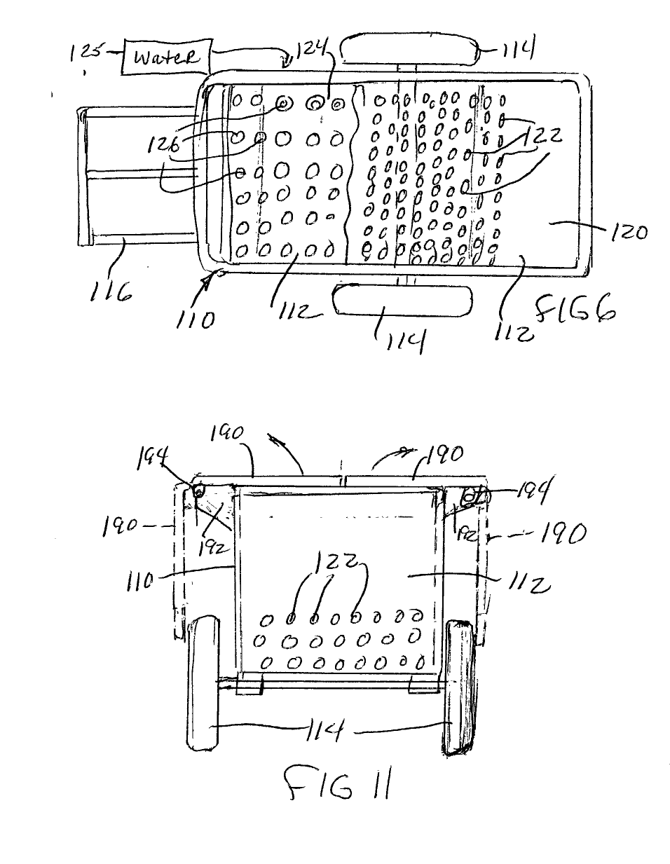

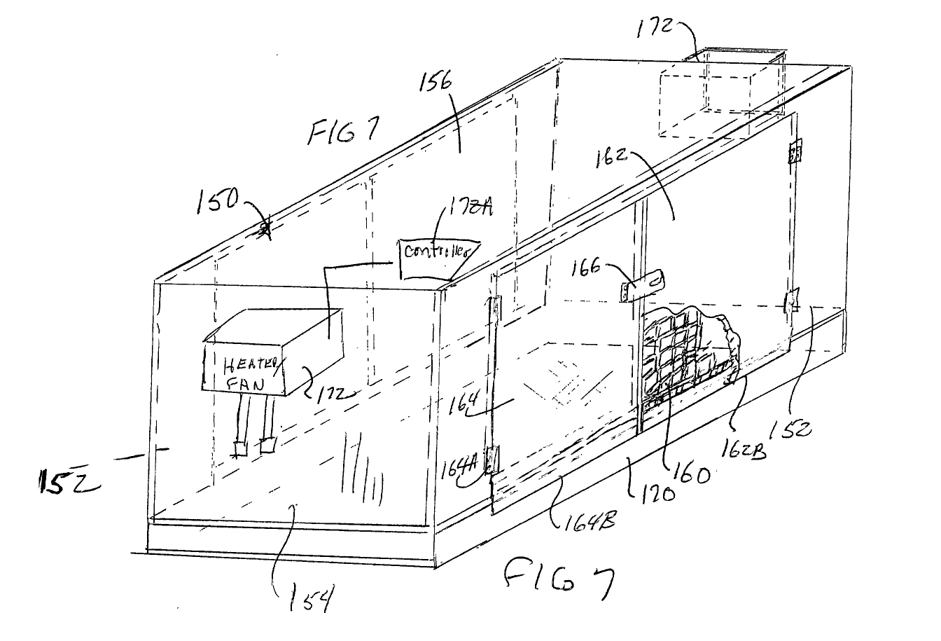

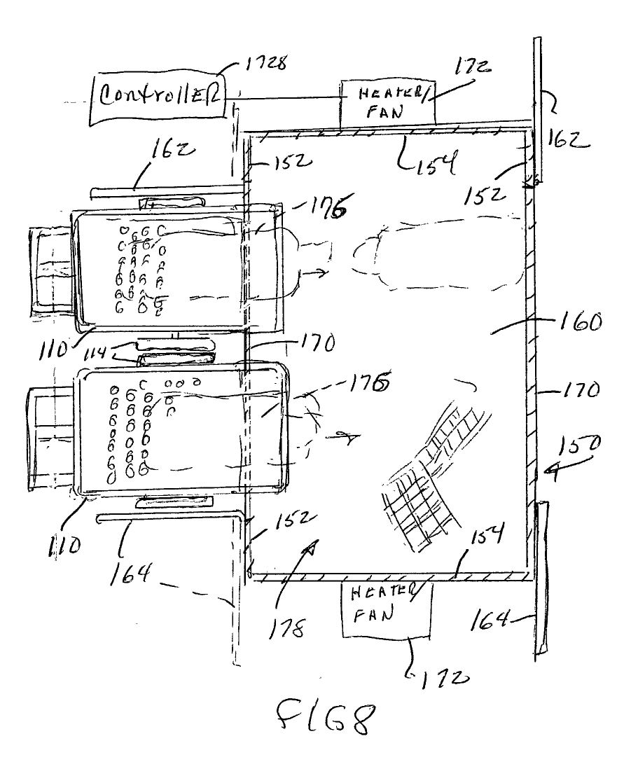

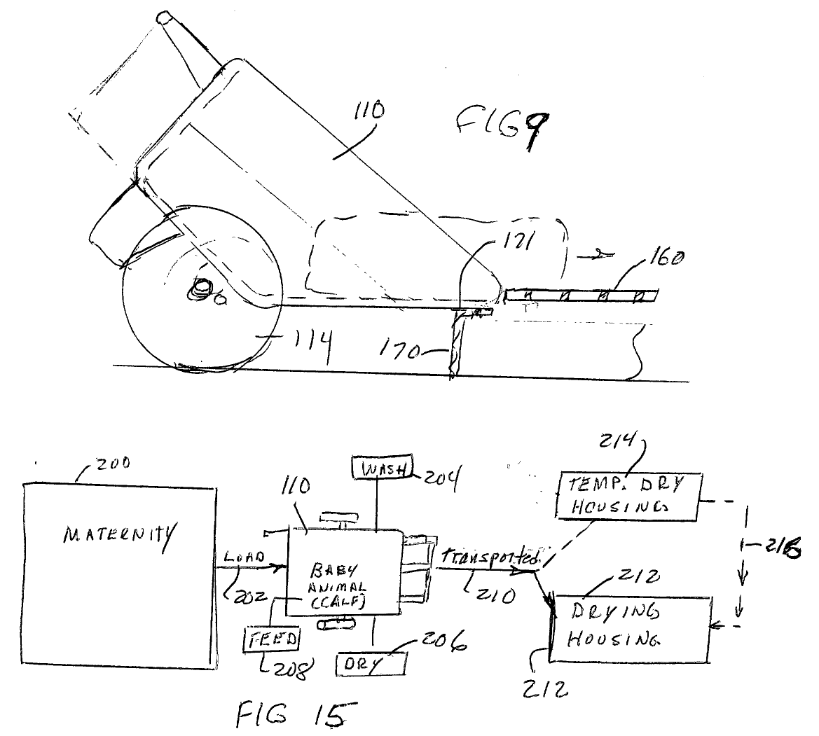

Referring to FIGS. 1, 2, and 3, a newborn calf drying and warming unit is shown at 10, and is shown on the top of a support 12 that can be a floor or other desired support, to raise it above the floor. The drying and working unit comprises a drying housing 14 that includes a lower or base section 16 that has a base or bottom wall 18, and upright side walls 20, that have upper edges. The upper edges of the walls 20 support a pair of tracks 21, on each side of the unit as shown in FIG. 3. The tracks 21 are generally inwardly facing channels 21 as shown in FIG. 3, and these channels 21 are used for supporting a drawer or slide 24. The drawer or slide 24 comprises a sturdy frame member 26 that has longitudinally extending slides 28, and end cross members 30. The calf support wall 32 is made of expanded metal that is covered with plastic. This type of material is a well known material. It is an open mesh as illustrated schematically. The openings can be a selected high percentage of the total area of the support or panel.

The longitudinal members 28 are provided with suitable plastic runners 32 on the top and bottom surfaces that will slide along the legs of the channel shaped tracks 21, and these slide members are such that they will permit sliding of the tray outwardly and inwardly along the tracks. The outer end of the tray includes a support strut 34 that is fixed to the cross member 30 and has a foot 36 at the bottom for supporting on the surface of the support 12 when the unit is extended. The base forward wall has a recess 38 for receiving the strut when the tray is slid into the interior of the housing 14.

The base 12 supports an enclosure or drying housing 40 that has a roof or top wall 42, side walls 44, and a front end wall 46, as well as a rear wall 48. The rear wall 48 can extend down and be part of the base rear wall, if desired. The front wall 46 has an opening 50 therein, and this opening 50 is of size to receive a newborn calf that is illustrated schematically at 52 in FIG. 2. The newborn calf is supported on the tray or slide 24 and can be loaded outside the drying housing with the tray extended as in FIG. 1, and then slid in.

The rear wall 48 is provided with a removable heater and blower housing 54, that can be fastened with suitable releasable fasteners 56 to the rear wall 48, and aligned with one or a plurality of openings or apertures 58 that lead from the heater housing 54 to the interior chamber of the drying and warming housing 40. The heater housing includes a heater 60 which can be an electric heater, a propane gas heater, or hot water heater. The heater housing also includes a blower or fan 62, which is shown schematically, and which can be electrically powered from a suitable power supply. The interior of the housing can have a suitable temperature sensor located in a desired location, and which is shown only schematically that will sense the temperature. The temperature sensor 64 is connected to a controller 66, which in turn, will control the heater 60 to maintain a desired temperature.

It should be noted that heater housing 54 can be removed by loosening the fasteners 56 and it can be replaced with a different type of heater as desired, so that if one wanted to use an electric heater in one place, it is a simple matter to change the heater housing and use a propane heater in another, or hot water heat if that is available, through suitable connections to a radiator that would be represented by 60 as well. The hot water can be supplied from a pasteurizer hot water heater.

In addition, a timer 68 can be used for limiting the length of time the heat is provided to the calf or other small animal 52, and the timer can be used for activating an alarm or signal that it is time to remove the animal.

In operation, the tray or shelf 24 can be extended as shown in FIG. 1, and a baby animal, then, placed on top of the expanded metal screen 32. This screen will permit air and liquids to pass through into the lower base and be supported on the floor 18. It will insure that any water or other liquid will drip off the animal. The shelf or tray is supported on the strut 34 and foot 36 when extended, and then is slid into position along the tracks 21 so that the animal is on the interior of the drying housing 40. Then, the heater would be started and air would be directed over the animal. The opening 50 can be left open or it can be closed, if desired, so that air will flow through the mesh wall 32 of the tray.

Air will flow down and across the animal and out through the outer end of the shelf, as shown schematically in FIG. 2 by the arrow 70.

When the time is appropriate, the animal will be dry, and will be ready for feeding and other treatment, and will have been maintained in an environment that is generally free of bacteria, viruses and parasites, and other types of disease-causing organisms. Once the animal is dry and fed, the animal then can be moved to a shelter or pen.

FIGS. 4-6 show a modified form of the invention. In this form of the invention, a drying housing 75, which also is a warming housing, and includes a base 76 that has upright walls 78 and a floor 80. An expanded metal calf support wall 82 is fixed, in this instance, to the tops of the side walls 78, 78, and spans the compartment or chamber shown at 84 in which an animal will be placed for drying and warming, and extends from end to end of the housing, as well. In this instance, the upper housing 86 has side walls 88, that are supported on the base, and an end wall 90, that is also supported on the base. The walls 88 can be continuations of the walls 78, and include large, outwardly pivoting side wall sections 92 on each of the sides. These wall sections are hinged with hinges 94 at their lower edge, and can be held closed with suitable fasteners or latches 96 at the upper end. The wall sections 92 form doors for access to the interior compartment 84. The wall section 92 can be folded outwardly, as shown in dotted lines in FIG. 4, to a substantially horizontal position, and a folding leg 98 can be attached with a bracket 100 to the wall section 92, to provide a support on the ground when the wall section 92 is in its horizontal position, as shown in dotted lines in FIG. 4.

One or both of the wall sections 92 can be hinged down at one time, and when horizontal the wall sections form a type of a shelf that can be used for receiving a baby animal, such as a calf, and then the calf can be slid into the interior compartment 84 on the lower support wall 82. The calf can actually be moved by lifting the side walls and letting the calf slide into the interior chamber 84.

In this form of the invention, the rear wall 90 has an opening 102 at the top, on which the heater housing, such as that shown at 54, can be mounted. In this instance, a heater is indicated at 104, and a fan is indicated at 106, while they are shown separated, they can be as a unit to provide an inflow of air into the interior compartment 84 to dry a small animal that is on the wall 82.

The support wall 82, again, can be open mesh expanded metal covered with plastic, so that liquid and waste can drop through down into the lower compartment and on the floor 80 and air also can flow down through the mesh.

In this form of the invention, there is an advantage of being able to transport a calf more easily toward the drying housing 75, as illustrated in FIG. 5. A large two-wheel cart 110, that has a hopper or bin 112 mounted on a pair of wheels 114, can be used for supporting a new born calf 115 and transporting it manually utilizing a handle 116, from the birth area over to the housing 75. The bin 112 has a base or support wall 120. Wall 120 is provided with a plurality of openings 122, and is covered with a soft rubber mat 124 that forms a cushion for holding a baby animal in place. The mat 124 has opening 126 that are over openings 122.

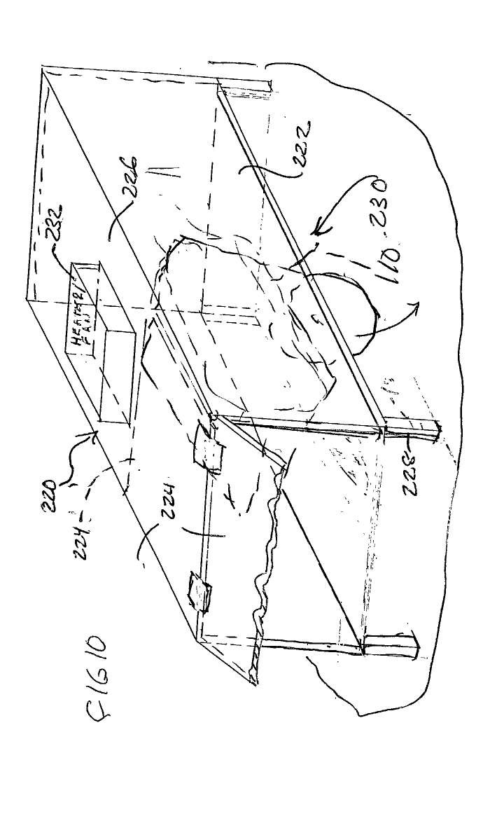

The openings 122 and 126 permit a calf to be washed with water in the cart. The water would give the calf a shower while it is in the cart. This, then, permits the water to drain. The mat 124 openings 126 permit water to drain out. This would permit a calf to be placed into the cart, washed or showered, with water from a source 125 and then squeegeed off or dried with mechanical means or quickly with a towel, and then transported over to the drying housing 75. It can be seen that with large wheels 114, the cart can be tilted so that the wall 120 rests on the top of the moveable side wall 92 of the warming housing and the calf, then, can merely be moved onto the wall section 92 and into the interior compartment or chamber 84 of the housing 75. At that time, the heaters and fan can be operated utilizing a temperature sensor and timer as previously described. A preferred form of the transport cart will have hinged covers, as shown in FIG. 11 to keep the baby calf contained.

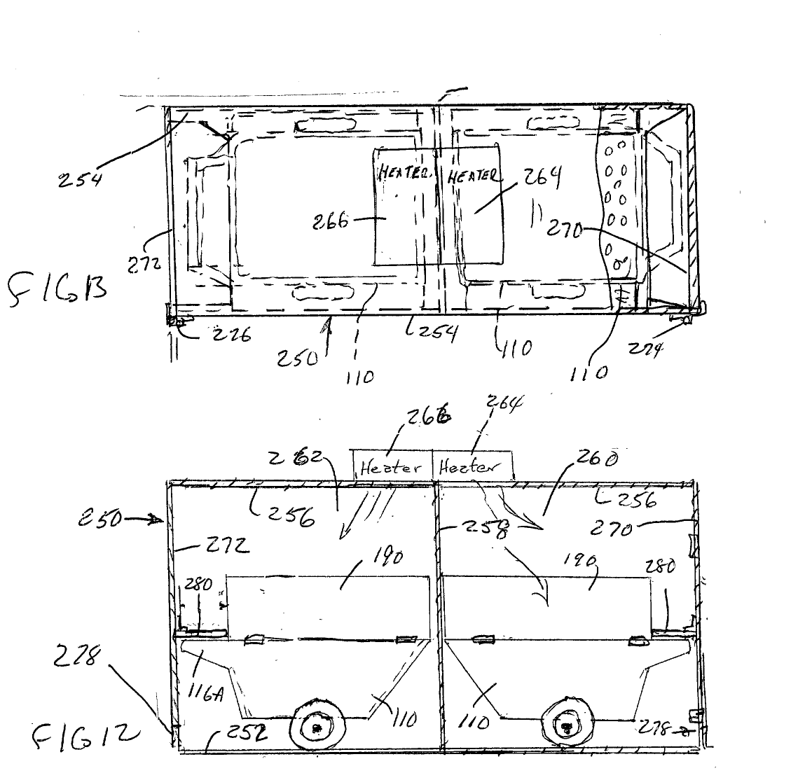

In large operations, where individual housings are impractical, although workable for spaced animal births, a multiple animal housing is provided, as shown in FIG. 7 (and also in FIGS. 12-14). In this form of the invention, a warming and drying housing 150 is made of suitable materials, and includes side walls 152, end walls 154, that join the side walls, and a top wall or cover 156. The bottom wall is illustrated at 160 is again an expanded metal so that it is an open mesh made up of criss-crossing bars that wind up looking diamond shapes, and this is covered with a suitable plastic to avoid injury or bruising to the baby animal that would be supported on it.

Each of the side walls, as shown typically in FIG. 7 for one of the walls, has a pair of doors 162 and 164 that are hinged as at 162A and 164A along end portions to the side walls 152. A suitable hasp or retainer hook 166 can be provided for holding the mating edges of the doors 162 and 164 together when they are closed as shown in FIG. 7. The hinges used can be any desired hinge, which will permit the doors to be swung fully open.

The bottom wall 154, as shown is offset upwardly from the lower edges 162B and 164B of the doors, by approximately 4-5 inches, and the floor panel 160 is raised in the range of 8-10 inches above the supporting surface or floor. This means that when the doors are open, as can be seen on the broken away portion of the door 162 in FIG. 7, the floor panel is above the upper edge of a lower side panel 170. This forms an edge that leaves the floor 160 raised above this edge that mates with the door edges 162B and 164B. This aids in unloading the animal from a cart.

A heater and fan module 172 is provided at one end, or both ends of the housing 150, as desired. The heater again can be an electric heater, or other types of heaters as previously discussed.

In FIG. 8, a top plan view is illustrated, and schematically shown, the doors are opened on both sides, and two carts 110 are shown. Two of the carts can be placed side-by-side on each side of the housing, and an animal indicated at 176 in each of the carts in dotted lines can then be moved into the interior compartment or chamber 178 of the housing 150 and supported on the expanded metal or open mesh work floor 160.

In this way, four (or more) animals can be placed into a single pen, and the heater modules 172 will be energized to blow fresh, warm air over the animals. The air can flow down through the floor, across the animal so that a flow is established.

As shown in FIG. 9, when a cart 110 is put in to position so that the hopper or bin 112 is tilted and rests against the upper edge 171 of the cross panel 170, the edge of the cart will be below the floor panel 160 and this will tend to permit easier removal of the animal onto the floor.

The baby animals will be washed in the cart, and as explained the cart bottom is perforated so that water will drain before the animal is put into place.

Once one or more animals are placed in the housing 150, the doors 162 and 164 can be closed with the hasp 166 and the heat source 172 is energized with a controller 172A that receives an input from a temperature sensor to provide a flow of heated air under fan pressure to warm the animals and prevent bacterial, viral and parasitic diseases.

FIG. 11 illustrates the cart 110 adapted for use with cover members 190, that will be permitted to overlie the upper end of the hopper or bin 112, which can be folded open so that animals can be placed in or removed easily. Even when tilted down, the doors will be folded down and will not interfere with tipping the cart upwardly, but will serve their function to retain an animal in the cart when desired.

As shown, a support arm 192 is provided on each side of the upper edge of the bin, and this will space out a support for hinge members 194 at the outer ends of the arms 192. The doors 190 are then hinged to the hinge member 194 on each side, and are made so that when they are folded closed they will meet in the center, and when opened they can be dropped vertically down without interfering with the wheels 114.

The cart 110 and rubber pad 124 that was previously described can be utilized with the cart 110 and the holes can be large enough to provide a flow of air.

FIG. 10 shows an optional drying housing or enclosure, that does not have to be loaded with the animal, but which has a door that can be raised or pivoted upwardly or may be swung open about a vertical hinge axis to permit the cart 110 to roll in for storage. Here, the housing or house 220 is made up of side walls 222, and an end wall at the opposite end from a door 224, which is shown as hinging upwardly, and shown in dotted lines over the top. The door could be hinged to swing in any direction. When it is hinged upwardly, it can be opened fully or supported sufficiently short so that a cart 110 can be rolled in under the upper wall 226. The walls 222 are spaced upwardly from the supporting surface, and thus are on legs 228 so that there is an open space 230 under the wall through which air from a heater and blower 232 can pass. The cart 110, as can be seen in schematically dotted lines, can be rolled directly under the blower and then the animal will have air flow over it, and the air will flow out through the bottom openings in the cart. The heater and blower arrangement can be an electric heater or other type of heater, but a flow of air that is warm and clean, and acts as a drying agent will be provided.

Housing 220 may be a temporary housing, for drying calves and keeping them from getting cold after they have been born, and placed into the transport cart 110 and, after they have been bottle fed colostrum. It is used when the warming and drying housings previously described are full of animals. The house also can have a floor for cleanliness if desired. The cart covers as shown in FIG. 11 can be opened for permitting air to enter the cart.

In FIGS. 12, 13 and 14, a double warming and drying housing is shown at 250. This double house or housing has a floor 252, and side walls 254 that are spaced apart sufficiently wide to permit a cart 110 that has the covers 190 in place, as shown in FIG. 11, to be wheeled into the housing. The side walls 254 support a roof 256, and there is a center divider wall 258 that divides the house or housing 250 into two compartments indicated at 260 and 262. The floor 252 extends across both of the compartments as can be seen, and the cart 110 with the side covers 190 hingedly mounted thereon will fit into the compartments 260 and 262 as shown schematically. Suitable heaters 264 and 266 are provided on the roof 256, and provide a flow of heated air into the interior compartments. These heaters also can be individually thermostatically controlled so that a desired temperature can be maintained. Airflow also can be controlled as desired. The compartments 260 and 262 are provided with doors 270 and 272, respectively, that are hinged about vertical axes with hinges 274 and 276. The doors 270 and 272 will swing open about a vertical axis, as shown, to permit the carts 110 to be moved into the respective compartments.

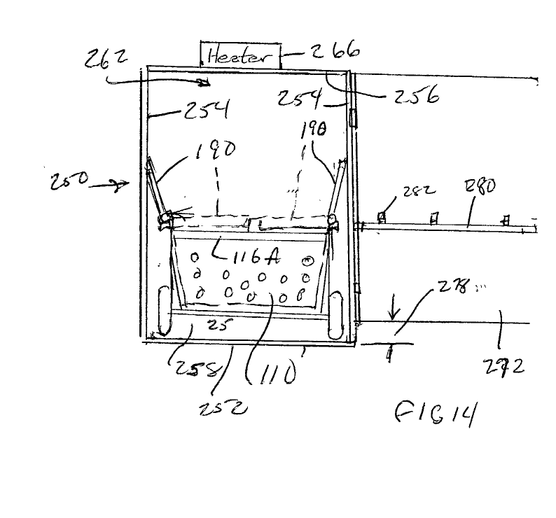

The doors terminate above the floors, as shown in FIG. 14 by a space indicated at 278 that provides for air exit, so that air can flow from the heaters as indicated by the arrows in FIG. 12 through the openings in the cart 110 previously shown, and across a baby animal in the cart.

It can be seen in FIG. 4 that the hinged covers 190 can be folded open and rested against the side walls 254, so that air can enter the carts.

The carts are shown in FIG. 12 with slightly different handles from the cart of FIG. 11. Handles would be used for manipulating the carts as previously explained.

In order to insure that an animal in the cart 110 does not struggle out of the cart, and become trapped in the spaces that are necessary for clearances for the handles shown at 116A in the compartments, a retainer shelf 280 is provided on suitable brackets 282 on each of the doors 270 and 272. The shelf is shown mounted in FIG. 14, and in FIG. 12, it can be seen that the shelves overlie the handles 116A, so that the space is covered. The shelves are close to the edges of the cart cover members 190 that fold outwardly and which are hinged to the body of the carts 110.

Again, the carts 110 have perforations in the bottom wall, so that air flows down into the cart and across the baby animal in the cart and then out through the space 278 at the bottoms of the doors.

The double housing, as shown, permits placing the carts into the compartments from the ends, but of course side doors could be used as well and the doors could hinge about horizontal axes and lift up if desired. The clearance space alongside the carts is covered by the cover members 190, when they lean against the side walls 252, so that the animal will not be trapped in any way, and essentially cannot get out of the cart.

Shelves 280 can be trimmed back at the corners so that the doors can swing open, of course, and the hinges can be of any standard hinge desired.

Carts 110 can have apertures in the bottom, as shown in FIGS. 11, and can be made of plastic material that can be washed and sanitized to avoid any possibility that organisms would be transferred from one baby calf or animal to another.

The process of the present invention is represented in FIG. 15, where a maternity pen or housing 200 for cows or other animals is provided. Once the baby animal has been born, it is immediately loaded as indicated at 202 into one of the carts 110 (which has been cleaned and disinfected) and then it is washed, and wiped so that excess water is removed from the animal's coat. Then the newborn animal is fed as soon as possible with colostrum.

The washing is represented at 204, wiping and drying is represented at 206 and feeding is at 208. Then the cart 110 is transported as indicated by arrow 210 to a selected warming and drying housing or the temporary drying housing. The housings are indicated in the process at 212 and 214. The warming and drying housing could be one of the housings such as that shown at 86, 40 or 250 for complete drying and further feeding. Alternately, the cart 110 can be placed into the temporary drying housing 214 and then after the warming and drying housing 212 is open, the cart can be transferred as indicated by 216 to the warming and drying housing 212 or 250 for completing the process, thus keeping the animal warm, drying the animal, and making it invigorated and ready to eat.

If the drying housings, which can be selected in size to accommodate a calf, are located in a separate room adjacent to the dairy barn, the heat source can be hot water from a milk pasteurizer system that would be passed through a heat exchanger, and then a fan would blow the heated air into the respective drying housings.

The cart 110 then forms as part of an entire system where the newborn calf or animal can be immediately placed into the cart, washed, partially dried, fed colostrum and then transported to a warming and drying housing such as housing 75, and kept in the warming and drying housing until it is dry and warm, after which it is then again fed and returned to its pen or other enclosure.

In this way, diseases are avoided, and it should be noted that the airflow that passes through the warming housing can be directed to the exterior, so that this air does not contact other small animals that may be susceptible to infections or diseases that are unknowingly carried by the animal being warmed.

Although the present invention has been described with reference to preferred embodiments, workers skilled in the art will recognize that changes may be made in form and detail without departing from the spirit and scope of the invention.

What is claimed is:

1. A baby animal warming and drying housing comprising a housing having at least a pair of side walls, and a roof to define an interior, a support for a baby animal, said support having perforations therethrough, and said support being positionable on the interior of the housing, a heater for heating the interior of the housing with a baby animal supported on the support.

2. The warming and drying housing of claim 1, wherein said support is a panel slidably mounted so that a major portion of the support panel can be positioned selectively on the interior of the housing and with a major portion on the exterior of the housing for receiving a baby animal.

3. The warming and drying housing of claim 1, wherein an end wall of the housing has an opening therethrough, said support panel comprising a support panel slidably mounted relative to the opening, and so that a major portion of the support panel is on the exterior of the housing, whereby a baby animal can be placed on the support panel and slid into the interior of the housing through the opening.

4. The warming and drying housing of claim 1, wherein there are end walls joining the side walls, at least one of the walls having at least sections hingedly attached to other portions of the walls, to permit opening a wall of the housing for introducing a baby animal into the interior.

5. The warming and drying housing of claim 4, wherein each of the pair of side walls has a wall section hingedly attached to other portions of the respective side wall, openable to permit access to the interior for placing baby animals in the interior of the housing.

6. The warming and drying housing of claim 5, wherein the housing is of size to enclose a plurality of baby animals.

7. The warming and drying housing of claim 5, wherein there are two wall sections on each of the side walls that are hingedly attached to other portions of the respective side walls, the hinged portions of the side walls meeting in a center line, and hinging outwardly therefrom.

8. The warming and drying housing of claim 1, wherein said support panel comprises a bottom wall of the housing, and comprises an open mesh material covered with a plastic.

9. The warming and drying housing of claim 1, wherein said heater comprises an electric heater.

10. The warming and drying housing of claim 1, wherein said heater comprises a water heater.

11. The warming and drying housing of claim 1, wherein said housing has a side wall section hingedly mounted to other portions of one side wall, said side wall section being hingable outwardly to a generally horizontal position to receive an animal to be placed in the housing.

12. The warming and drying housing of claim 1, wherein the support comprises a wheeled transport cart for a baby animal, used in combination with the housing, the housing having an openable wall portion for receiving the wheeled transport cart into the interior of the housing.

13. The combination of claim 12, wherein said transport cart has sloping side walls and a bottom wall, and a plurality of the perforations being in the bottom wall of the transport cart for permitting draining of liquids from the interior of the transport cart.

14. Combination of claim 13, and a rubber mat having perforations overlying the sloping and bottom walls of the transport cart, whereby liquids on the interior of the transport cart can drain through the rubber pad and the wall of the cart.

15. An animal transport cart comprising a bin shaped compartment having a wall forming a receptacle, wheels for supporting the bin shaped receptacle for movement over a surface, said cart being inclinable about the axis of the wheels to lower a forward edge of the bin shaped housing as it is inclined, and the wall forming a bottom of the bin and having a plurality of perforations therethrough for permitting fluids to flow through the perforations.

16. The cart of claim 15, wherein the cart has a resilient perforated pad over the perforated wall.

17. The cart of claim 15, and a cover over the top of the cart, said cover being hingedly attached to the cart and moveable from a position overlying a top opening of the bin shaped receptacle to a position where the cover clears the top opening of the bin shaped receptacle.

18. The cart of claim 15, wherein the cover comprises two cover sections, one hinged on each of a pair of side walls of the card.

19. A combination of a warming and drying housing for baby animals with a transport cart comprising a housing having walls defining an interior enclosure and a floor and a roof, an access door openable to permit access to the interior enclosure, a controllable heater to heat the interior enclosure of the housing and provide a flow of air through the interior enclosure, the housing having an opening near the floor for permitting airflow to exit the interior enclosure, a wheeled transport cart, said cart having a wall forming a bottom, front and rear walls, and side walls to define a cavity, the front, rear and bottom walls being perforated to permit airflow therethrough, said cart being of size to fit within the interior enclosure.

20. The combination of claim 19 and a pair of covers hingedly attached to the side walls of the cart and moveable from a position overlying an upper opening of the cart to positions wherein the covers are clear of the top opening.

21. The combination of claim 20, wherein the side walls of the housing are spaced from the side walls of a cart positioned in the interior enclosure a distance that permits the covers to rest against the respective side walls when the covers are opened.

22. The combination of claim 21, wherein the access door that is hingeable to permit access to the interior enclosure of the housing extends generally perpendicular to the side walls of the housing against which the covers of the cart rest, the cart having a handle extending from the rear wall of the cart outwardly, said interior enclosure being of size to receive the cart including the handle, and said door being closeable with the cart in the enclosure, said door having a shelf that overlies the handle of the cart when the door is closed.

23. The combination of claim 19, wherein said housing is a double wide housing, said housing having separate doors at opposite ends thereof for permitting two carts to be inserted into the housing, a divider wall dividing the housing into two interior enclosures each of which is of size to receive the wheeled transport cart, and a separate heater for each of the interior enclosures.

24. The process of caring for newborn animals comprising the step of placing a newborn animal into a cart a bottom wall and side walls, the bottom wall having a plurality of perforations therethrough, comprising showering the newborn animal in the cart, and partially drying the animal while in the cart, moving the cart to a warming and drying housing, tilting the cart to lower an edge thereof to a level of a support panel in the warming and drying housing, and removing the newborn animal from the cart and placing the newborn animal in the interior of the warming and drying housing.

25. The process of claim 24, including the step of providing a clean warm airflow over the animal in the warming and drying housing until the animal is dried.

26. The process of claim 24, including an intermediate step of moving the cart into a temporary warming enclosure having an overlying heater and blower, whereby air is blown over the cart and a newborn animal in the cart before moving the animal to the warming and drying housing.

27. The process of claim 25, wherein said process includes controlling the warm airflow for a selected time.
